(19) United States
(12) Patent Application Publication
(10) Pub. No.: US 2008/0250977 A1
(43) Pub. Date: Oct. 16, 2008

(54) Oxime free anti-skinning combination

(76) Inventors: Andrew Mason, County Durham (GB); John Birkett, County Durham (GB); Paul Thomas, County Durham (GB)

Correspondence Address: MORGAN, LEWIS & BOCKIUS LLP, 1701 MARKET STREET, PHILADELPHIA, PA, 19103-2921, US

(21) Appl. No.: 11/787,709

(22) Filed: Apr. 16, 2007

(51) Int. Cl. C09K 15/32

(52) U.S. Cl. 106/287.3; 252/397; 252/400.24

(57) ABSTRACT

The present invention relates to an antiskinning composition containing an organic oxygen scavenger and at least one drying accelerator.

### FIELD OF THE INVENTION

This invention relates to the use of non-oxime oxygen scavengers and/or antioxidants as anti-skinning agents.

### BACKGROUND

Skin formation in air-drying paints/coatings during manufacturing and storage is undesirable. Skin formation can lead to material losses and usage problems due to remaining skin particles in the paint causing surface irregularities.

Oximes, which act as oxygen scavengers, or suitable phenolic compounds are most often used today as anti-skinning agents in industry. Oximes, such as methylethylketoxime (2-butanone oxime) (MEKO) binds to the free coordination sites of the metal carboxylate, such as cobalt, preventing the metal from binding with oxygen and thereby preventing the drying process. With MEKO the “bonding” is weak and as MEKO is volatile, an excess is required to ensure good performance. Additionally, the excess creates an inert atmosphere in the coating storage container, thus preventing the ingress of oxygen. Upon opening of the container the MEKO evaporates. The MEKO bound to the cobalt starts to dissociate and as such the cobalt is free to bind to oxygen and start the drying process.

A significant disadvantage of oximes is their toxicity. Users often must practice extreme personal protection precautions when working with paints containing oximes as anti-skinning agents. As a result, industry has an interest in compounds and formulations which can be used for oxime free antiskinning in coatings and as blocking agents. As with MEKO, these materials function as antiskinning agents by binding to the active ingredient or free coordination sites. In oxidatively drying systems, the catalyst is a metal carboxylate (drier/siccative). Cobalt is often the favored metal for the initiation and driving of the drying process. Oxime free systems work in a similar manner in that they bind to the cobalt. The strength of this association is different from one material to another.

Diethylhydroxylamine has found use as an anti-skinning agent because it binds to cobalt more strongly than MEKO but not so strongly that the drying process is stopped completely. In these systems, there is generally less requirement to have an inert atmosphere in the storage container, and therefore a smaller amount of the anti-skinning agent is required. The primary drawback to these systems is that they bind to cobalt more strongly than MEKO and as such they do not dissociate at the same rate, the result of which is poorer drying. Attempts have been made to balance this negative effect by the addition of an accelerator to promote the drying process. Materials in the market place that use this technology have not been successful because when adequate antiskinning performance has been achieved it has been to the detriment of the drying performance.

### SUMMARY OF THE INVENTION

The present invention provides for an antiskinning composition including about 80 to about 90 weight percent of an organic oxygen scavenger and about 10 to about 20 weight percent of at least one drying accelerator. In some embodiments the organic oxygen scavenger is a hydroxylamine, such as diethylhydroxylamine. In some embodiments, the drying accelerator is a phosphite, such as such as triphenylphosphite.

The present invention provides for a method of producing a coating material containing an antiskinning composition.

The present invention provides for an article coated with a coating material containing an antiskinning composition.

In some embodiments, an antiskinning composition includes more than one drying accelerator. In some embodiments, an antiskinning composition contains a combination of triphenylphosphite and basic strontium. In some embodiments, an antiskinning composition contains about 40 to about 95 weight percent diethylhydroxylamine, about 5 to about 20 weight percent triphenylphosphite, and up to about 40 weight percent strontium carboxylate.

### DETAILED DESCRIPTION OF THE INVENTION

The present invention relates to an anti-skinning composition containing an organic oxygen scavenger and at least one drying accelerator. The composition may be incorporated in coating materials, paint, or finish to provide antiskinning properties without causing an adverse effect on drying and other film properties.

The antiskinning composition of the present invention is oxime free. Oxime free systems work in a similar manner to MEKO in that they bind to cobalt in the coating material to which they are added. The strength of this association is different from one material to another. In a preferred embodiment, the oxygen scavenger may be added to a coating material where it may impair the oxidative process of the coating material during storage. In a preferred embodiment, an organic oxygen scavenger of the present invention binds to cobalt more strongly than MEKO but not so strong that the drying process of the coating material is completely hindered. In some embodiments, an organic oxygen scavenger may not readily dissociate from the cobalt, resulting in poor or delayed drying of the coating material. A negative effect on drying may be counter-balanced by the addition of a drying accelerator. In a preferred embodiment of the present invention, the combination of an oxygen scavenger and a drying accelerator are formulated to form an antiskinning composition which, when added to a coating material, achieves a balance allowing for impairment of the oxidative process during storage of the coating material, while showing minimal impairment of the oxidative process when the coating material is in use.

A further advantage of the antiskinning composition of the present invention is higher effectiveness as an antiskinning agent compared to MEKO. As a result of the higher effectiveness, a lower amount of the antiskinning composition is required in order to achieve substantially the same results as MEKO. The current invention, thus allows users greater flexibility when using a coating material containing an antiskinning composition of the present invention. Additionally, oxime based antiskinning agents have a known toxicity, and as such are classified as class III 2A carcinogens. The current invention utilizes the very effective antiskinning properties of the hydroxylamine countered with the accelerating properties of the phosphite.

An antiskinning composition of the present invention may be useful in oxidative drying systems, for example, in coatings of internal and external application, wood coatings and stains, short to long oil alkyds and modified alkyds, including newer developments designed to meet new legislative criteria on volatile organic content. In certain embodiments, an antiskinning composition of the present invention may be added to coating materials in an amount of about 0.005 to about 0.080 weight percent. In other embodiments, an antiskinning composition of the present invention may be added to coating materials in an amount of about 0.015 to about 0.050 weight percent.

An organic oxygen scavenger is a material which exhibits the ability to complex with free oxygen and slow its reactions. When added to coating materials, paints, or finishes, organic oxygen scavengers may be useful to prevent undesirable skinning. Representative examples of organic oxygen scavengers include but are not limited to amines, aldehydes, ketones, sulfites, and phenol derivatives such as hydroquinones. In some embodiments, the oxygen scavenger is a hydroxylamine, such as diethylhydroxylamine.

The organic oxygen scavenger may be present in an amount of about 40 to about 95 weight percent. In some embodiments, the oxygen scavenger is present in an amount of about 80 to about 90 weight percent, or more preferably about 84 to 88 weight percent. In a preferred embodiment, the oxygen scavenger is present in an amount of about 86 weight percent.

While the oxygen scavengers may prevent undesirable skinning in coating materials, paints, or finishes, the oxygen scavengers may also cause the coating materials, paints, or finishes to dry improperly or more slowly. To counter the oxygen scavenger's adverse effect on drying, one or more drying accelerator may be added to the antiskinning composition.

Representative examples of drying accelerators useful in the present antiskinning composition are phosphites, phosphates, amines and amine derivatives. In some embodiments, the drying accelerator may be an aryl phosphite, such as triphenylphosphite. A drier with a metal concentration of greater than 20 weight percent metal may also be used, such as basic strontium, specifically strontium carboxylate. In some embodiments, a combination of drying accelerators may be added to the antiskinning composition. One embodiment may include a combination of triphenylphosphite and basic strontium.

Drying accelerators may be present in an amount of about 5 to about 60 weight percent. In some embodiments, drying accelerators may be present in an amount of about 10 to about 20 weight percent, or more preferably about 12 to about 16 weight percent. In a preferred embodiment, drying accelerators may be present in an amount of about 14 weight percent.

In one embodiment, an antiskinning composition of the present invention may contain about 40 to 95 weight percent diethylhydroxylamine, about 5 to about 20 weight percent triphenylphosphite, and up to about 40 weight percent strontium carboxylate.

The oxygen scavenger and drying accelerator may be mixed by any standard mixing technique. In some embodiments, the oxygen scavenger and drying accelerator are liquid and may be mixed together by stirring or shaking. For small batches, an overhead stirrer may be used.

An anti skinning composition of the present invention may be added to a coating material by any standard mixing technique. Low-shear mixing methods are suitable. In some embodiments the antiskinning composition may be mixed in the coating material at a rate of about 10 rpms to about 500 rpms.

Coating materials containing an antiskinning composition of the present invention may be applied to an article in a manner appropriate for the specific coating material.

In certain embodiments, the weight percentage of antiskinning composition of the present invention which is needed in order to provide substantially the same properties as MEKO in a coating material is at least an order of magnitude lower than the required weight percentage of MEKO. In some embodiments, the reduced amount of antiskinning composition which is required may be due to a difference in the complexation strength of MEKO as compared to an antiskinning composition of the present invention. In practice, MEKO is often added to a coating material in excess, such that the equilibrium is in favor of the MEKO-cobalt complex in the coating material during storage and skinning of the coating material is prevented. When the coating material container is opened, the excess MEKO may be lost rapidly due to its high volatility. The loss of MEKO may shift the equilibrium and release the cobalt, thereby allowing proper drying of the coating material. In some embodiments, antiskinning compositions of the present invention do not have the same volatility or complexation characteristics as MEKO. In certain embodiments, less anti skinning composition of the present invention than MEKO is needed to prevent skinning in a coating material during storage, and a drying accelerator of the present invention balances the antiskinning effectiveness to allow proper drying of the coating material. This reduced amount is an additional benefit of antiskinning compositions of the present invention over MEKO.

### EXAMPLES

The following examples involve the use of an antiskinning composition according to the present invention compared to the use of MEKO in various coating materials. For the following examples, an antiskinning composition of the present invention was prepared by mixing 14.03 weight percent triphenylphosphite and 85.97 weight percent diethylhydroxylamine (DEHA/TPP). The DEHA and TPP were mixed by stirring with an overhead stirrer until well-blended. The DEHA/TPP was then added to a coating material and mixed by hand. The coating materials with the DEHA/TPP were sealed and stored for 24 hours to 6 months, as specified for each example below.

The compositions of each of the following examples were tested for (1) antiskinning properties, (2) drying properties, (3) hardness, and (4) color. The description of each test and the results for each coating material tested follow the numbered examples. Test results are set forth in the accompanying tables.

### Comparative Example 1

0.400 grams MEKO were added to 200 grams long oil alkyd decorative gloss, resulting in 0.200 weight percent MEKO. 0.200 grams DEHA/TPP were added to 200 grams long oil alkyd decorative gloss, resulting in 0.024 weight percent DEHA/TPP. The paint with the MEKO showed skinning after 20 days, and the paint with the DEHA/TPP showed skinning after 19 days.

### Comparative Example 2

0.400 grams MEKO were added to 200 grams long oil alkyd decorative gloss, resulting in 0.200 weight percent MEKO. 0.200 grams DEHA/TPP were added to 200 grams long oil alkyd decorative gloss, resulting in 0.024 weight percent DEHA/TPP. The paint with the MEKO showed skinning after 10 days, and the paint with the DEHA/TPP showed skinning after 13 days.

### Comparative Example 3

0.400 grams MEKO were added to 200 grams long oil alkyd decorative gloss, resulting in 0.200 weight percent MEKO. 0.200 grams DEHA/TPP were added to 200 grams long oil alkyd decorative gloss, resulting in 0.024 weight percent DEHA/TPP. The paint with the MEKO showed skinning after 10 days, and the paint with the DEHA/TPP showed skinning after 14 days.

### Comparative Example 4

0.400 grams MEKO were added to 200 grams long oil alkyd decorative gloss, resulting in 0.200 weight percent MEKO. 0.200 grams DEHA/TPP were added to 200 grams long oil alkyd decorative gloss, resulting in 0.024 weight percent DEHA/TPP. The paint with the MEKO showed skinning after 15 days, and the paint with the DEHA/TPP showed skinning after 17 days.

### Comparative Example 5

0.400 grams MEKO were added to 200 grams medium oil alkyd decorative gloss, resulting in 0.200 weight percent MEKO. 0.280 grams DEHA/TPP were added to 200 grams medium oil alkyd decorative gloss, resulting in 0.035 weight percent DEHA/TPP. The paint with the MEKO showed skinning after 14 days, and the paint with the DEHA/TPP also showed skinning after 14 days.

### Comparative Example 6

0.400 grams MEKO were added to 200 grams short oil alkyd, resulting in 0.200 weight percent MEKO. 0.340 grams DEHA/TPP were added to 200 grams short oil alkyd, resulting in 0.043 weight percent DEHA/TPP. The paint with the MEKO showed skinning after 8 days, and the paint with the DEHA/TPP showed skinning after 11 days.

### Comparative Example 7

0.400 grams MEKO were added to 200 grams short oil alkyd primer, resulting in 0.200 weight percent MEKO. 0.280 grams DEHA/TPP were added to 200 grams short oil alkyd primer, resulting in 0.035 weight percent DEHA/TPP. The paint with the MEKO showed skinning after 11 days, and the paint with the DEHA/TPP also showed skinning after 11 days.

### Comparative Example 8

0.400 grams MEKO were added to 200 grams short oil alkyd primer, resulting in 0.200 weight percent MEKO. 0.280 grams DEHA/TPP were added to 200 grams short oil alkyd primer, resulting in 0.035 weight percent DEHA/TPP. The paint with the MEKO showed skinning after 5 days, and the paint with the DEHA/TPP also showed skinning after 5 days.

### Comparative Example 9

0.400 grams MEKO were added to 200 grams short oil alkyd primer, resulting in 0.200 weight percent MEKO. 0.280 grams DEHA/TPP were added to 200 grams short oil alkyd primer, resulting in 0.035 weight percent DEHA/TPP. The paint with the MEKO showed skinning after 11 days, and the paint with the DEHA/TPP showed skinning after 14 days.

### Comparative Example 10

0.400 grams MEKO were added to 200 grams decorative woodstain, resulting in 0.200 weight percent MEKO. 0.280 grams DEHA/TPP were added to 200 grams decorative woodstain, resulting in 0.035 weight percent DEHA/TPP. The woodstain with the MEKO showed skinning after 20 days, and the woodstain with the DEHA/TPP showed skinning after 23 days.

### Comparative Example 11

0.400 grams MEKO were added to 200 grams long oil thixotropic alkyd, resulting in 0.200 weight percent MEKO. 0.200 grams DEHA/TPP were added to 200 grams long oil thixotropic alkyd, resulting in 0.024 weight percent DEHA/TPP. The paint with the MEKO showed skinning after 5 days, and the paint with the DEHA/TPP also showed skinning after 5 days.

### Comparative Example 12

0.400 grams MEKO were added to 200 grams long oil volatile organic content (VOC) reduced alkyd gloss, resulting in 0.200 weight percent MEKO. 0.200 grams DEHA/TPP were added to 200 grams long oil VOC reduced alkyd gloss, resulting in 0.024 weight percent DEHA/TPP. The paint with the MEKO showed skinning after 10 days, and the paint with the DEHA/TPP showed skinning after 14 days.

### Comparative Example 13

0.400 grams MEKO were added to 200 grams long oil VOC reduced alkyd gloss, resulting in 0.200 weight percent MEKO. 0.200 grams DEHA/TPP were added to 200 grams long oil VOC reduced alkyd gloss, resulting in 0.024 weight percent DEHA/TPP. The paint with the MEKO showed skinning after 8 days, and the paint with the DEHA/TPP showed skinning after 10 days.

### Comparative Example 14

0.400 grams MEKO were added to 200 grams long oil VOC reduced alkyd gloss, resulting in 0.200 weight percent MEKO. 0.200 grams DEHA/TPP were added to 200 grams long oil VOC reduced alkyd gloss, resulting in 0.024 weight percent DEHA/TPP. The paint with the MEKO showed skinning after 16 days, and the paint with the DEHA/TPP showed skinning after 22 days.

The coating materials containing the antiskinning materials as described above were tested for (1) antiskinning, (2) drying, (3) hardness, and (4) color. Descriptions of the tests and the test results for each coating material tested are set forth below.

Antiskinning Tests: The coating materials containing an antiskinning composition according to the present invention and containing MEKO, as described in the numbered examples above, were each tested for antiskinning properties and compared. The antiskinning properties were measured in terms of the number of days until the coating material displayed skinning.

TABLE 1
Days to Skinning

| Example | MEKO | DEHA/TPP |
|---|---|---|
| 1 | 20 | 19 |
| 2 | 10 | 13 |
| 3 | 10 | 14 |
| 4 | 15 | 17 |
| 5 | 14 | 14 |
| 6 | 8 | 11 |
| 7 | 11 | 11 |
| 8 | 5 | 5 |
| 9 | 11 | 14 |
| 10 | 20 | 23 |
| 11 | 5 | 5 |
| 12 | 10 | 14 |
| 13 | 8 | 10 |
| 14 | 16 | 22 |

The results of the antiskinning test demonstrate that antiskinning compositions according to the present invention, which include an organic oxygen scavenger such as diethylhydroxylamine and a drying accelerator such as triphenylphosphite, perform as well or better than MEKO as an antiskinning agent in almost all of the coating materials tested. In nine of the fourteen coating materials tested, the DEHA/TPP prevented skinning of the coating material for a longer period of time. In four coating materials tested, the DEHA/TPP provided equivalent antiskinning as the MEKO.

Drying Tests: The drying times of each coating material containing antiskinning compositions as described in the examples above were measured at various conditions:

Test 1: Coating material with antiskinning compositions were stored for 24 hours; drying tests were run at 24-27° C. and 46-59% humidity.

Test 2: Coating material with antiskinning compositions were stored for 4 weeks; drying tests were run at 24-27° C. and 46-53% humidity.

Test 3: Coating material with antiskinning compositions were stored for 6 months; drying tests were run at 23-35° C. and 61-65% humidity.

Test 4: Coating material with antiskinning compositions were stored for 1 month at 50° C.; drying tests were run at 24° C. and 44-60% humidity.

Test 5: Coating material with antiskinning compositions were stored for 2 months at 50° C.; drying tests were run at 25-26° C. and 56-65% humidity.

The drying tests were performed with Beck-Koller driers, model BK#3, using a wet film thickness of nominally 75 μm. The drying times were measured in terms of four stages, defined as follows:

Stage 1, Run back: Stage 1 is characterized by the evaporation of solvent from the film. During this stage, the paint is still liquid. As such, when a needle is run through the paint, the paint reforms the complete film and no groove is formed. When the film first shows a break or groove, this time is recorded as “run back.’

Stage 2, Start of gel tear: During Stage 2, substantially all of the solvent has evaporated from the film, though the surface of the film has not formed a skin. As a result, when a needle is run through the paint, a clean groove is left in the film. When this clean, paint-free, groove is no longer former, this point is recorded as “Start of Gel Tear.”

Stage 3, End of gel tear: During Stage 3, the film has developed a surface skin, which may snag and pull when a needle is run through the paint. The result is a line of holes and unbroken film. When holes are no longer developed in the film, this time is recorded as “End of Gel Tear.”

Stage 4, End of track: During Stage 4, a needle run along the film produces a scratch which may be seen only on the surface of the film. When a scratch is no longer formed on the surface of the film, this time is recorded as “End of Track.”

These stages do not correspond exactly to Touch Dry, Tack Free, and Hard Dry which are terms used in other drying tests. The test results are listed in the tables below:

TABLE 2
24 hour test, run at 24-27° C. and 46-59% humidity

| | Coating | | | Drying time (hours) | | | |
|---|---|---|---|---|---|---|---|
| Example | material | Test conditions | Percent additive | Stage 1 | Stage 2 | Stage 3 | Stage 4 |
| 1 | long oil alkyd | 26° C. and 55% | 0.200% MEKO | 0.3 | 3 | 3.4 | 8.5 |
| | decorative gloss | humidity | 0.024% DEHA/TPP | 0.4 | 1.9 | 2.2 | 8.3 |
| 2 | long oil alkyd | 26° C. and 55% | 0.200% MEKO | 1.9 | 2.6 | 4.8 | 7 |
| | decorative gloss | humidity | 0.024% DEHA/TPP | 2.3 | 3 | 5.9 | 8.1 |
| 3 | long oil alkyd | 26° C. and 55% | 0.200% MEKO | 3.9 | 4.2 | 6.75 | 7.2 |
| | decorative gloss | humidity | 0.024% DEHA/TPP | 5 | 6 | 9.25 | 9.25 |
| 4 | long oil alkyd | 26° C. and 55% | 0.200% MEKO | 0.9 | 1.9 | 3.3 | 8.4 |
| | decorative gloss | humidity | 0.024% DEHA/TPP | 0.75 | 2.6 | 5 | 11.4 |
| 5 | medium oil | 24° C. and 46% | 0.200% MEKO | 1.1 | 2.75 | 2.75 | 4.75 |
| | alkyd decorative | humidity | 0.035% DEHA/TPP | 1.5 | 4.9 | 5.5 | 7.1 |
| | gloss | | | | | | |
| 6 | short oil alkyd | 26° C. and 59% | 0.200% MEKO | 0 | 0.2 | 4.9 | 6.75 |
| | | humidity | 0.043% DEHA/TPP | 0.05 | 0.25 | 6.9 | 12.1 |
| 7 | short oil alkyd | 27° C. and 58% | 0.200% MEKO | 0.5 | 2.5 | 2.7 | 4.1 |
| | primer | humidity | 0.035% DEHA/TPP | 1 | 4.5 | 4.6 | 4.7 |
| 8 | short oil alkyd | 27° C. and 58% | 0.200% MEKO | 0.1 | 0.7 | 1.75 | 2.7 |
| | primer | humidity | 0.035% DEHA/TPP | 0.1 | 0.7 | 2.9 | 3.5 |
| 9 | short oil alkyd | 27° C. and 58% | 0.200% MEKO | 0.2 | 1.25 | 1.75 | 2.75 |
| | primer | humidity | 0.035% DEHA/TPP | 0.2 | 1.7 | 2.6 | 3.5 |
| 10 | woodstain | 26° C. and 55% | 0.200% MEKO | 0.8 | 4.8 | 5.7 | 5.7 |
| | | humidity | 0.035% DEHA/TPP | 0.8 | 4.6 | 6.1 | 6.6 |
| 11 | long oil | 26° C. and 55% | 0.200% MEKO | 0.3 | 6.9 | 7.8 | 9.5 |
| | thixotropic | humidity | 0.024% DEHA/TPP | 0.4 | 9.8 | 10.2 | 10.9 |
| | alkyd | | | | | | |
| 12 | long oil VOC | 24° C. and 46% | 0.200% MEKO | 2.7 | 3.2 | 3.4 | 6 |
| | reduced alkyd | humidity | 0.024% DEHA/TPP | 4.5 | 5 | 5 | 5.6 |
| | gloss | | | | | | |
| 13 | long oil VOC | 24° C. and 46% | 0.200% MEKO | 1.5 | 5 | 5.8 | 7 |
| | reduced alkyd | humidity | 0.024% DEHA/TPP | 2 | 8.25 | 8.5 | 9.5 |
| | gloss | | | | | | |
| 14 | long oil VOC | 24° C. and 46% | 0.200% MEKO | 2.9 | 8 | 9.2 | 9.8 |
| | reduced alkyd | humidity | 0.024% DEHA/TPP | 2.5 | 8.4 | 8.7 | 9.1 |
| | gloss | | | | | | |

TABLE 3
4 week test, run at 24-27° C. and 46-53% humidity

| | Coating | | | Drying time (hours) | | | |
|---|---|---|---|---|---|---|---|
| Example | material | Test conditions | Percent additive | Stage 1 | Stage 2 | Stage 3 | Stage 4 |
| 1 | long oil alkyd | 24° C. and 53% | 0.200% MEKO | 1 | 9.4 | 10.1 | 10.6 |
| | decorative gloss | humidity | 0.024% DEHA/TPP | 1.2 | 9.6 | 10.6 | 11.2 |
| 2 | long oil alkyd | 24° C. and 53% | 0.200% MEKO | 1 | 4.5 | 5 | 10.3 |
| | decorative gloss | humidity | 0.024% DEHA/TPP | 1 | 5.2 | 6 | 12 |
| 3 | long oil alkyd | 24° C. and 53% | 0.200% MEKO | 0.4 | 4.3 | 4.9 | 8.8 |
| | decorative gloss | humidity | 0.024% DEHA/TPP | 0.7 | 4.2 | 4.5 | 6.3 |
| 4 | long oil alkyd | 24° C. and 53% | 0.200% MEKO | 7.3 | 7.7 | 8.7 | 13.5 |
| | decorative gloss | humidity | 0.024% DEHA/TPP | 6.8 | 8 | 9 | 11.3 |
| 5 | medium oil | 26° C. and 50% | 0.200% MEKO | 1.2 | 4.9 | 5.1 | 7.6 |
| | alkyd decorative | humidity | 0.035% DEHA/TPP | 0.8 | 5 | 6.1 | 6.4 |
| | gloss | | | | | | |
| 6 | short oil alkyd | 27° C. and 49% | 0.200% MEKO | 0.1 | 0.4 | 0.4 | 11.1 |
| | | humidity | 0.043% DEHA/TPP | 0 | 0.2 | 1.1 | 13.1 |
| 7 | short oil alkyd | 24° C. and 46% | 0.200% MEKO | 2.2 | 3 | 3.3 | 4.3 |
| | primer | humidity | 0.035% DEHA/TPP | 2 | 4 | 4.1 | 5 |
| 8 | short oil alkyd | 24° C. and 46% | 0.200% MEKO | 0 | 1 | 1.8 | 2.5 |
| | primer | humidity | 0.035% DEHA/TPP | 0 | 1 | 2.5 | 3 |
| 9 | short oil alkyd | 24° C. and 46% | 0.200% MEKO | 0.2 | 1.2 | 2.3 | 3.5 |
| | primer | humidity | 0.035% DEHA/TPP | 0.3 | 2.2 | 3 | 4.2 |
| 10 | woodstain | 24° C. and 46% | 0.200% MEKO | 5.2 | 6.6 | 6.7 | 7.5 |
| | | humidity | 0.035% DEHA/TPP | 5 | 6 | 6.7 | 7.1 |
| 11 | long oil | 24° C. and 49% | 0.200% MEKO | 1 | 8.4 | 9.2 | 10 |
| | thixotropic alkyd | humidity | 0.024% DEHA/TPP | 0.8 | 6.1 | 6.7 | 7.5 |
| 12 | long oil VOC | 26° C. and 50% | 0.200% MEKO | 5.8 | 6 | 6.3 | 7.2 |
| | reduced alkyd | humidity | 0.024% DEHA/TPP | 4.7 | 5 | 5.1 | 5.7 |
| | gloss | | | | | | |
| 13 | long oil VOC | 26° C. and 50% | 0.200% MEKO | 1.1 | 6.3 | 7.5 | 9.5 |
| | reduced alkyd | humidity | 0.024% DEHA/TPP | 1.4 | 8.3 | 9.1 | 11.5 |
| | gloss | | | | | | |
| 14 | long oil VOC | 26° C. and 50% | 0.200% MEKO | 1.8 | 11.1 | 11.8 | 13.9 |
| | reduced alkyd | humidity | 0.024% DEHA/TPP | 2.4 | 10.8 | 12.3 | 13.1 |
| | gloss | | | | | | |

TABLE 4
6 month test, run at 23-35° C. and 61-65% humidity

| | | Test | | Drying time (hours) | | | |
|---|---|---|---|---|---|---|---|
| Example | Coating material | conditions | Percent additive | Stage 1 | Stage 2 | Stage 3 | Stage 4 |
| 1 | long oil alkyd | 23° C. and 65% | 0.200% MEKO | 1 | 6.2 | 7.2 | 8.4 |
| | decorative gloss | humidity | 0.024% DEHA/TPP | 1.1 | 6.7 | 7.3 | 8.7 |
| 2 | long oil alkyd | 35° C. and 65% | 0.200% MEKO | 3.7 | 5.2 | 5.9 | 10.8 |
| | decorative gloss | humidity | 0.024% DEHA/TPP | 3.5 | 5.4 | 6.3 | 11 |
| 3 | long oil alkyd | 23° C. and 65% | 0.200% MEKO | 5.5 | 6.1 | 7.5 | 8.9 |
| | decorative gloss | humidity | 0.024% DEHA/TPP | 5.5 | 6.3 | 7 | 8.4 |
| 4 | long oil alkyd | 23° C. and 65% | 0.200% MEKO | 0.9 | 6.5 | 7.6 | 11.4 |
| | decorative gloss | humidity | 0.024% DEHA/TPP | 1.1 | 5.8 | 7 | 10.7 |
| 5 | medium oil alkyd | 23° C. and 65% | 0.200% MEKO | 0.9 | 4.7 | 4.9 | 6.2 |
| | decorative gloss | humidity | 0.035% DEHA/TPP | 1 | 4.8 | 5.2 | 5.8 |
| 6 | short oil alkyd | 23° C. and 65% | 0.200% MEKO | 0 | 0.2 | 0.5 | 11.1 |
| | | humidity | 0.043% DEHA/TPP | 0 | 0.2 | 0.6 | 12.4 |
| 7 | short oil alkyd | 24° C. and 61% | 0.200% MEKO | 2.7 | 3.5 | 4 | 4.9 |
| | primer | humidity | 0.035% DEHA/TPP | 3.1 | 4.5 | 4.8 | 6 |
| 8 | short oil alkyd | 24° C. and 61% | 0.200% MEKO | 0 | 1.25 | 1.75 | 2.75 |
| | primer | humidity | 0.035% DEHA/TPP | 0.2 | 1.4 | 1.9 | 3 |
| 9 | short oil alkyd | 24° C. and 61% | 0.200% MEKO | 0.25 | 1.75 | 2.4 | 3 |
| | primer | humidity | 0.035% DEHA/TPP | 0.25 | 2.25 | 2.6 | 3.2 |
| 10 | woodstain | 24° C. and 61% | 0.200% MEKO | 1.1 | 5.2 | 6.3 | 6.8 |
| | | humidity | 0.035% DEHA/TPP | 1.6 | 5 | 5.9 | 6.3 |
| 11 | long oil | 24° C. and 61% | 0.200% MEKO | 0.7 | 7 | 7.3 | 9.6 |
| | thixotropic alkyd | humidity | 0.024% DEHA/TPP | 0.8 | 5.6 | 6 | 7.2 |
| 12 | long oil VOC | 23° C. and 62% | 0.200% MEKO | 8.4 | 8.6 | 8.8 | 10 |
| | reduced alkyd | humidity | 0.024% DEHA/TPP | 6.5 | 7.3 | 8 | 8.7 |
| | gloss | | | | | | |
| 13 | long oil VOC | 23° C. and 62% | 0.200% MEKO | 1.7 | 7.9 | 9.2 | 12.1 |
| | reduced alkyd | humidity | 0.024% DEHA/TPP | 2 | 8.5 | 9.9 | 10.5 |
| | gloss | | | | | | |
| 14 | long oil VOC | 23° C. and 62% | 0.200% MEKO | 2.1 | 13.6 | 14.7 | 16.1 |
| | reduced alkyd | humidity | 0.024% DEHA/TPP | 2.4 | 13.1 | 14 | 14.8 |
| | gloss | | | | | | |

TABLE 5
1 month at 50° C. test, run at 24° C. and 44-60% humidity

| | | Test | | Drying time (hours) | | | |
|---|---|---|---|---|---|---|---|
| Example | Coating material | conditions | Percent additive | Stage 1 | Stage 2 | Stage 3 | Stage 4 |
| 1 | long oil alkyd | 24° C. and 49% | 0.200% MEKO | 0.5 | 5.25 | 6 | 8.2 |
| | decorative gloss | humidity | 0.024% DEHA/TPP | 0.6 | 4.7 | 5 | 6.25 |
| 2 | long oil alkyd | 24° C. and 49% | 0.200% MEKO | 5.7 | 6.7 | 7.1 | 11.75 |
| | decorative gloss | humidity | 0.024% DEHA/TPP | 5.8 | 7.3 | 7.5 | 11 |
| 3 | long oil alkyd | 24° C. and 60% | 0.200% MEKO | 6.5 | 7 | 7 | 8.1 |
| | decorative gloss | humidity | 0.024% DEHA/TPP | 7.6 | 8 | 8 | 9.6 |
| 4 | long oil alkyd | 24° C. and 49% | 0.200% MEKO | 0.4 | 5.3 | 6.2 | 10.2 |
| | decorative gloss | humidity | 0.024% DEHA/TPP | 0.6 | 4.9 | 5.2 | 9.4 |
| 5 | medium oil alkyd | 24° C. and 54% | 0.200% MEKO | 0.75 | 4.2 | 4.5 | 7 |
| | decorative gloss | humidity | 0.035% DEHA/TPP | 0.8 | 4.7 | 5.6 | 7 |
| 6 | short oil alkyd | 24° C. and 49% | 0.200% MEKO | 0 | 0.2 | 0.5 | 11.8 |
| | | humidity | 0.043% DEHA/TPP | 0 | 0.2 | 0.4 | 13 |
| 7 | short oil alkyd | 24° C. and 54% | 0.200% MEKO | 0.75 | 3.8 | 4.2 | 6.5 |
| | primer | humidity | 0.035% DEHA/TPP | 0.75 | 2.3 | 2.5 | 5 |
| 8 | short oil alkyd | 24° C. and 54% | 0.200% MEKO | 0 | 0.4 | 0.5 | 2.8 |
| | primer | humidity | 0.035% DEHA/TPP | 0.1 | 0.5 | 0.5 | 2.4 |
| 9 | short oil alkyd | 24° C. and 54% | 0.200% MEKO | 0.25 | 2 | 2.4 | 3.7 |
| | primer | humidity | 0.035% DEHA/TPP | 0.25 | 1.5 | 1.7 | 2.7 |
| 10 | woodstain | 24° C. and 50% | 0.200% MEKO | 2.2 | 5.2 | 6.1 | 6.6 |
| | | humidity | 0.035% DEHA/TPP | 2.25 | 5.15 | 6.1 | 6.3 |
| 11 | long oil | 24° C. and 50% | 0.200% MEKO | 0.5 | 6.5 | 7.15 | 8.8 |
| | thixotropic alkyd | humidity | 0.024% DEHA/TPP | 0.5 | 4.35 | 4.85 | 6.6 |
| 12 | long oil VOC | 24° C. and 50% | 0.200% MEKO | 9.2 | 9.6 | 9.6 | 10.6 |
| | reduced alkyd | humidity | 0.024% DEHA/TPP | 6.6 | 7.1 | 7.3 | 9.5 |
| | gloss | | | | | | |
| 13 | long oil VOC | 24° C. and 50% | 0.200% MEKO | 1.2 | 13.3 | 14 | 17.1 |
| | reduced alkyd | humidity | 0.024% DEHA/TPP | 1 | 12.5 | 14.1 | 15 |
| | gloss | | | | | | |
| 14 | long oil VOC | 24° C. and 50% | 0.200% MEKO | 5.4 | 15 | 15.2 | 15.6 |
| | reduced alkyd | humidity | 0.024% DEHA/TPP | 4.25 | 14.7 | 15.1 | 17.2 |
| | gloss | | | | | | |

TABLE 6
2 months at 50° C. test, run at 25-26° C. and 5665% humidity

| | Coating | | | Drying time (hours) | | | |
|---|---|---|---|---|---|---|---|
| Example | material | Test conditions | Percent additive | Stage 1 | Stage 2 | Stage 3 | Stage 4 |
| 1 | long oil alkyd | 26° C. and 62% | 0.200% MEKO | 0.4 | 5.6 | 6.2 | 10 |
| | decorative gloss | humidity | 0.024% DEHA/TPP | 0.6 | 6.8 | 7.5 | 9.9 |
| 2 | long oil alkyd | 26° C. and 62% | 0.200% MEKO | 7.4 | 8.9 | 9.8 | 13.5 |
| | decorative gloss | humidity | 0.024% DEHA/TPP | 6.7 | 8.7 | 10.4 | 14.5 |
| 3 | long oil alkyd | 26° C. and 62% | 0.200% MEKO | 7.4 | 7.9 | 8.2 | 9.5 |
| | decorative gloss | humidity | 0.024% DEHA/TPP | 8.2 | 8.6 | 9.5 | 10.1 |
| 4 | long oil alkyd | 26° C. and 62% | 0.200% MEKO | 1.1 | 7.6 | 8.2 | 12.4 |
| | decorative gloss | humidity | 0.024% DEHA/TPP | 0.8 | 5.9 | 6.5 | 10 |
| 5 | medium oil | 25° C. and 56% | 0.200% MEKO | 0.6 | 5 | 6.4 | 7.4 |
| | alkyd decorative | humidity | 0.035% DEHA/TPP | 0.5 | 4.2 | 5.2 | 5.8 |
| | gloss | | | | | | |
| 6 | short oil alkyd | 25° C. and 64% | 0.200% MEKO | 0 | 0.2 | 0.6 | 14.1 |
| | | humidity | 0.043% DEHA/TPP | 0 | 0.5 | 0.8 | 15.8 |
| 7 | short oil alkyd | n/a | 0.200% MEKO | n/a | | | |
| | primer | | 0.035% DEHA/TPP | | | | |
| 8 | short oil alkyd | 25° C. and 65% | 0.200% MEKO | 0 | 0.7 | 1.8 | 2.6 |
| | primer | humidity | 0.035% DEHA/TPP | 0.1 | 0.7 | 1.9 | 2.5 |
| 9 | short oil alkyd | 25° C. and 56% | 0.200% MEKO | 0.1 | 1.5 | 2.4 | 2.4 |
| | primer | humidity | 0.035% DEHA/TPP | 0.2 | 1.4 | 2 | 2 |
| 10 | woodstain | 26° C. and 59% | 0.200% MEKO | 0.8 | 5.7 | 6.8 | 7.5 |
| | | humidity | 0.035% DEHA/TPP | 1.4 | 5.5 | 6.4 | 7.4 |
| 11 | long oil | 26° C. and 59% | 0.200% MEKO | 0.7 | 6.7 | 7.6 | 11.7 |
| | thixotropic alkyd | humidity | 0.024% DEHA/TPP | 0.2 | 4 | 4.5 | 4.7 |
| 12 | long oil VOC | 26° C. and 59% | 0.200% MEKO | 6.7 | 7 | 7.3 | 8.7 |
| | reduced alkyd | humidity | 0.024% DEHA/TPP | 5 | 5.3 | 5.3 | 8.1 |
| | gloss | | | | | | |
| 13 | long oil VOC | 26° C. and 59% | 0.200% MEKO | 3.7 | 14.6 | 18.6 | 19.6 |
| | reduced alkyd | humidity | 0.024% DEHA/TPP | 2.5 | 8.3 | 10.1 | 14.9 |
| | gloss | | | | | | |
| 14 | long oil VOC | 25° C. and 56% | 0.200% MEKO | 1 | 14.6 | 15.9 | 16.2 |
| | reduced alkyd | humidity | 0.024% DEHA/TPP | 1.45 | 14.3 | 15.5 | 16.7 |
| | gloss | | | | | | |

The drying test results listed in the tables above demonstrate that an antiskinning composition according to the present invention, which contains an antiskinning agent such as diethylhydroxylamine and a drying accelerator such as triphenylphosphite, does not substantially hinder drying when added to a coating material, as compared to the drying times of the coating materials containing MEKO. A comparison of the drying times for each of the four stages of drying demonstrates that the drying performance of the coating materials containing an antiskinning composition according to the present invention is substantially similar to that of the same coating materials containing MEKO.

Hardness Tests: The coating materials containing an antiskinning composition according to the present invention and containing MEKO were each tested for hardness by measuring the Koenig Pendulum hardness development as a percent of glass of a film of wet film thickness of nominally 75 μm. The hardness was measured at 1, 2, 5, 6, 7, 14, 21, and 28 days. As can be seen in the results in the tables below for each coating material, the hardness development throughout the course of the 28 days of the coating materials containing an antiskinning composition according to the present invention is substantially the same as the hardness development of the coating materials containing MEKO.

TABLE 7
Koenig Pendulum Hardness Development as a Percentage of Glass

| | Antiskinning | Hardness Development as a Percentage of Glass | | | | | | | |
|---|---|---|---|---|---|---|---|---|---|
| Example | Composition | Day 1 | Day 2 | Day 5 | Day 6 | Day 7 | Day 14 | Day 21 | Day 28 |
| 1 | DEHA/TPP | 11.8% | 15.1% | 19.9% | 22.5% | 24.2% | 26.1% | 26.1% | 28.6% |
| | MEKO | 10.6% | 15.1% | 19.9% | 22.5% | 24.2% | 26.1% | 26.1% | 28.6% |
| 2 | DEHA/TPP | 5.6% | 8.8% | 9.0% | 11.2% | 13.5% | 16.7% | 18.3% | 20.0% |
| | MEKO | 6.2% | 8.8% | 9.6% | 11.2% | 12.9% | 16.1% | 18.3% | 20.0% |
| 3 | DEHA/TPP | 6.8% | 7.5% | 9.6% | 12.4% | 13.5% | 15.6% | 15.6% | 16.2% |
| | MEKO | 7.5% | 8.8% | 10.3% | 12.4% | 13.5% | 15.6% | 15.6% | 16.2% |
| 4 | DEHA/TPP | 11.2% | 13.2% | 17.3% | 18.5% | 19.7% | 20.6% | 21.1% | 22.2% |
| | MEKO | 11.2% | 15.1% | 17.9% | 18.5% | 19.7% | 20.6% | 21.1% | 22.2% |
| 5 | DEHA/TPP | 10.6% | 11.3% | 12.8% | 12.9% | 13.5% | 13.9% | 13.9% | 14.1% |
| | MEKO | 11.2% | 11.9% | 13.5% | 13.5% | 13.5% | 13.9% | 13.9% | 14.1% |
| 6 | DEHA/TPP | 18.6% | 29.6% | 44.2% | 56.2% | 59.0% | 60.6% | 62.2% | 63.2% |
| | MEKO | 23.6% | 32.1% | 44.9% | 56.7% | 59.0% | 60.6% | 62.2% | 63.2% |
| 7 | DEHA/TPP | 11.2% | 11.9% | 12.8% | 12.4% | 12.9% | 13.3% | 13.3% | 13.5% |
| | MEKO | 11.8% | 12.6% | 12.8% | 12.9% | 12.9% | 13.3% | 13.3% | 13.5% |
| 8 | DEHA/TPP | 16.1% | 19.5% | 34.6% | 36.0% | 34.8% | 35.6% | 36.1% | 36.2% |
| | MEKO | 17.4% | 20.1% | 35.9% | 36.0% | 34.8% | 35.6% | 36.1% | 36.2% |
| 9 | DEHA/TPP | 14.3% | 22.0% | 25.0% | 25.8% | 25.8% | 26.1% | 26.1% | 26.5% |
| | MEKO | 15.5% | 23.3% | 25.6% | 25.3% | 25.8% | 26.1% | 26.1% | 26.5% |
| 10 | DEHA/TPP | n/a | n/a | n/a | n/a | n/a | n/a | n/a | n/a |
| | MEKO | n/a | n/a | n/a | n/a | n/a | n/a | n/a | n/a |
| 11 | DEHA/TPP | 11.2% | 17.0% | 25.0% | 28.1% | 30.9% | 31.1% | 32.2% | 33.5% |
| | MEKO | 11.8% | 17.0% | 23.7% | 28.1% | 30.9% | 31.1% | 32.2% | 33.5% |
| 12 | DEHA/TPP | 0% | 0% | 0% | 0% | 0% | 0% | 0% | 0% |
| | MEKO | 0% | 0% | 0% | 0% | 0% | 0% | 0% | 0% |
| 13 | DEHA/TPP | 11.8% | 14.5% | 19.9% | 22.5% | 24.7% | 24.4% | 25.0% | 25.4% |
| | MEKO | 12.4% | 15.1% | 19.9% | 23.0% | 24.2% | 24.4% | 24.4% | 25.4% |
| 14 | DEHA/TPP | 11.2% | 12.6% | 16.7% | 18.0% | 20.2% | 21.1% | 22.2% | 23.8% |
| | MEKO | 11.2% | 13.2% | 16.7% | 18.0% | 20.2% | 21.1% | 21.7% | 23.8% |

Color test: Some antiskinning compositions are known to affect coloring when added to coating compositions. To test for color change in the coating materials of examples 1-14, properties were measured for each coating material containing an antiskinning composition according to the present invention and for each coating material containing MEKO with a wet-film thickness of 150 μm. A color value, L/a*/b*, was measured on Day 0, and the change in colour from the initial value was measured and recorded after 1 month and after 6 months.

TABLE 8
Color Test

| | Antiskinning | | | | | |
|---|---|---|---|---|---|---|
| Example | Composition | Age | | L | a* | b* |
| 1 | DEHA/TPP | 0 | days | 96.54 | −0.76 | 4.70 |
| | MEKO | 0 | days | 96.51 | −0.65 | 4.50 |
| | DEHA/TPP | 28 | days | 96.48 | −0.78 | 4.25 |
| | MEKO | 28 | days | 96.47 | −0.7 | 4.2 |
| | DEHA/TPP | 6 | mths | 96.42 | −0.65 | 4.70 |
| | MEKO | 6 | mths | 96.51 | −0.60 | 4.60 |
| 2 | DEHA/TPP | 0 | days | 96.30 | −0.84 | 3.80 |
| | MEKO | 0 | days | 96.4 | −0.85 | 3.30 |
| | DEHA/TPP | 28 | days | 96.32 | −0.74 | 3.7 |
| | MEKO | 28 | days | 96.57 | −0.7 | 3.5 |
| | DEHA/TPP | 6 | mths | 96.38 | −0.91 | 5.21 |
| | MEKO | 6 | mths | 96.54 | −0.98 | 4.89 |
| 3 | DEHA/TPP | 0 | days | 96.00 | −0.25 | 2.40 |
| | MEKO | 0 | days | 95.74 | −0.17 | 2.60 |
| | DEHA/TPP | 28 | days | 96.1 | −0.17 | 2.38 |
| | MEKO | 28 | days | 95.84 | −0.15 | 2.25 |
| | DEHA/TPP | 6 | mths | 96.03 | −0.36 | 3.88 |
| | MEKO | 6 | mths | 95.80 | −0.32 | 3.98 |
| 4 | DEHA/TPP | 0 | days | 94.20 | −0.60 | 0.40 |
| | MEKO | 0 | days | 94.00 | −0.70 | 0.50 |
| | DEHA/TPP | 28 | days | 94.15 | −0.54 | 0.43 |
| | MEKO | 28 | days | 94.05 | −0.68 | 0.49 |
| | DEHA/TPP | 6 | mths | 94.14 | −0.86 | 1.70 |
| | MEKO | 6 | mths | 93.95 | −0.90 | 1.96 |
| 5 | DEHA/TPP | 0 | days | 96.50 | −0.75 | 4.72 |
| | MEKO | 0 | days | 96.50 | −0.72 | 4.60 |
| | DEHA/TPP | 28 | days | 96.57 | −0.88 | 4.6 |
| | MEKO | 28 | days | 96.6 | −0.81 | 4.58 |
| | DEHA/TPP | 6 | mths | 96.41 | −0.92 | 6.71 |
| | MEKO | 6 | mths | 96.27 | −0.91 | 6.70 |
| 6 | DEHA/TPP | 0 | days | 95.85 | −0.48 | 4.95 |
| | MEKO | 0 | days | 95.92 | −0.42 | 4.85 |
| | DEHA/TPP | 28 | days | 95.54 | −0.75 | 4.7 |
| | MEKO | 28 | days | 95.64 | −0.65 | 4.65 |
| | DEHA/TPP | 6 | mths | 95.56 | −0.67 | 5.45 |
| | MEKO | 6 | mths | 95.62 | −0.70 | 5.42 |
| 7 | DEHA/TPP | 0 | days | 96.14 | −0.60 | 3.70 |
| | MEKO | 0 | days | 96.20 | −0.58 | 3.65 |
| | DEHA/TPP | 28 | days | 96.07 | −0.5 | 3.18 |
| | MEKO | 28 | days | 96.1 | −0.51 | 3.2 |
| | DEHA/TPP | 6 | mths | 96.05 | −0.68 | 4.70 |
| | MEKO | 6 | mths | 96.05 | −0.63 | 4.50 |
| 8 | DEHA/TPP | 0 | days | 94.79 | −0.49 | 6.51 |
| | MEKO | 0 | days | 94.80 | −0.51 | 6.40 |
| | DEHA/TPP | 28 | days | 95.02 | −0.45 | 6.1 |
| | MEKO | 28 | days | 94.95 | −0.43 | 6.18 |
| | DEHA/TPP | 6 | mths | 95.14 | −0.40 | 7.20 |
| | MEKO | 6 | mths | 95.10 | −0.39 | 7.02 |
| 9 | DEHA/TPP | 0 | days | 95.48 | −0.80 | 5.86 |
| | MEKO | 0 | days | 95.40 | −0.81 | 5.95 |
| | DEHA/TPP | 28 | days | 95.3 | −0.8 | 5.99 |
| | MEKO | 28 | days | 95.2 | −0.81 | 6.02 |
| | DEHA/TPP | 6 | mths | 95.34 | −0.83 | 7.45 |
| | MEKO | 6 | mths | 95.34 | −0.83 | 7.59 |
| 10 | DEHA/TPP | 0 | days | n/a | n/a | n/a |
| | MEKO | 0 | days | n/a | n/a | n/a |
| | DEHA/TPP | 28 | days | n/a | n/a | n/a |
| | MEKO | 28 | days | n/a | n/a | n/a |
| | DEHA/TPP | 6 | mths | n/a | n/a | n/a |
| | MEKO | 6 | mths | n/a | n/a | n/a |
| 11 | DEHA/TPP | 0 | days | n/a | n/a | n/a |
| | MEKO | 0 | days | n/a | n/a | n/a |
| | DEHA/TPP | 28 | days | n/a | n/a | n/a |
| | MEKO | 28 | days | n/a | n/a | n/a |
| | DEHA/TPP | 6 | mths | n/a | n/a | n/a |
| | MEKO | 6 | mths | n/a | n/a | n/a |
| 12 | DEHA/TPP | 0 | days | 96.63 | −0.70 | 4.30 |
| | MEKO | 0 | days | 96.58 | −0.75 | 4.48 |
| | DEHA/TPP | 28 | days | 96.45 | −0.85 | 4.6 |
| | MEKO | 28 | days | 96.4 | −0.92 | 4.78 |
| | DEHA/TPP | 6 | mths | 96.08 | −1.46 | 7.95 |
| | MEKO | 6 | mths | 95.90 | −1.39 | 8.21 |
| 13 | DEHA/TPP | 0 | days | 96.71 | −0.70 | 3.86 |
| | MEKO | 0 | days | 96.80 | −0.78 | 3.90 |
| | DEHA/TPP | 28 | days | 96.38 | −0.72 | 3.95 |
| | MEKO | 28 | days | 96.4 | −0.7 | 3.95 |
| | DEHA/TPP | 6 | mths | 96.33 | −0.90 | 5.89 |
| | MEKO | 6 | mths | 96.30 | −.0.88 | 5.89 |
| 14 | DEHA/TPP | 0 | days | 95.60 | −0.80 | 3.50 |
| | MEKO | 0 | days | 95.48 | −0.78 | 3.48 |
| | DEHA/TPP | 28 | days | 95.84 | −0.77 | 3.6 |
| | MEKO | 28 | days | 95.8 | −0.75 | 3.65 |
| | DEHA/TPP | 6 | mths | 95.86 | −0.90 | 5.65 |
| | MEKO | 6 | mths | 95.70 | −0.86 | 5.55 |

The color test results in Table 8 demonstrate that in the tested coating materials, the addition of an antiskinning composition according to the present invention in each coating material produced substantially the same color changes as the addition of MEKO.

As demonstrated by the tests presented herein, an antiskinning composition according to the present invention provides substantially similar antiskinning properties as MEKO when added to coating materials, but a significantly smaller amount of the antiskinning composition is needed. Additionally, an antiskinning composition according to the present invention produced similar results as MEKO in the tested coating materials for drying properties, hardness development, and color change.

The present disclosure may be embodied in other specific forms without departing from the spirit or essential attributes of the invention. Accordingly, reference should be made to the appended claims, rather than the foregoing specification, as indicating the scope of the disclosure. Although the foregoing description is directed to the preferred embodiments of the disclosure, it is noted that other variations and modification will be apparent to those skilled in the art, and may be made without departing from the spirit or scope of the disclosure.

We claim:

1. An antiskinning composition comprising:
a) an organic oxygen scavenger in an amount of about 80 to about 90 weight percent; and,
b) a drying accelerator in an amount of about 10 to about 20 weight percent.

2. The antiskinning composition of claim 1, wherein the organic oxygen scavenger is present in an amount of about 84 to about 88 weight percent, and the drying accelerator is present in an amount of about 12 to about 16 weight percent.

3. The antiskinning composition of claim 1, wherein the organic oxygen scavenger is present in an amount of 86 weight percent and the drying accelerator is present in the amount of about 14 weight percent.

4. The antiskinning composition of claim 1, wherein the organic oxygen scavenger is a hydroxylamine and the drying accelerator is a phosphite.

5. The antiskinning composition of claim 4, wherein the hydroxylamine is diethylhydroxylamine and the phosphite is triphenylphosphite.

6. The antiskinning composition of claim 1, wherein organic oxygen scavenger is present in an amount of about 84 to about 88 weight percent.

7. The antiskinning composition of claim 1, wherein the organic oxygen scavenger is present in an amount of 86 weight percent.

8. The antiskinning composition of claim 1, wherein the organic oxygen scavenger is a hydroxylamine.

9. The antiskinning composition of claim 8, wherein the hydroxylamine is diethylhydroxylamine.

10. The antiskinning composition of claim 1, wherein the drying accelerator is present in an amount of about 12 to about 16 weight percent.

11. The antiskinning composition of claim 1, wherein the drying accelerator is present in the amount of about 14 weight percent.

12. The antiskinning composition of claim 1, wherein the drying accelerator is a phosphite.

13. The antiskinning composition of claim 12, wherein the phosphite is triphenylphosphite.

14. An antiskinning agent of claim 1, further comprising an additional drying accelerator with a metal concentration greater than 20 weight percent.

15. The antiskinning composition of claim 14, wherein the additional drying accelerator is basic strontium.

16. An antiskinning composition comprising
a) diethylhydroxylamine in an amount of about 80 to about 90 weight percent, and
b) triphenylphosphite in an amount of about 10 to about 20 weight percent.

17. A coating material, paint, or finish containing, as an antiskinning agent, the antiskinning composition of claim 1.

18. A method of producing a coating material, paint, or finish containing an antiskinning composition comprising, incorporating into the coating material, paint, or finish, an antiskinning composition comprising
a) an organic oxygen scavenger in an amount of about 80 to about 90 weight percent; and,
b) a drying accelerator in an amount of about 10 to about 20 weight percent.

19. The method of claim 18, wherein the organic oxygen scavenger is present in an amount of about 84 to about 88 weight percent, and the drying accelerator is present in an amount of about 12 to about 16 weight percent.

20. The method of claim 18, wherein the organic oxygen scavenger is present in an amount of 86 weight percent and the drying accelerator is present in the amount of about 14 weight percent.

21. The method of claim 18, wherein the organic oxygen scavenger is a hydroxylamine and the drying accelerator is a phosphite.

22. The method of claim 18, wherein the hydroxylamine is diethylhydroxylamine and the phosphite is triphenylphosphite.

23. An article coated with a coating material, paint, or finish containing an antiskinning composition, wherein an antiskinning composition comprising
a) an organic oxygen scavenger in an amount of about 80 to about 90 weight percent; and,
b) a drying accelerator in an amount of about 10 to about 20 weight percent.
is incorporated into the coating material, paint, or finish.

24. The article of claim 23 wherein the organic oxygen scavenger is present in an amount of about 84 to about 88 weight percent, and the drying accelerator is present in an amount of about 12 to about 16 weight percent.

25. The article of claim 23 wherein the organic oxygen scavenger is present in an amount of 86 weight percent and the drying accelerator is present in the amount of about 14 weight percent.

26. The article of claim 23 wherein the organic oxygen scavenger is a hydroxylamine and the drying accelerator is a phosphite.

27. The article of claim 23 wherein the hydroxylamine is diethylhydroxylamine and the phosphite is triphenylphosphite.

28. An antiskinning composition comprising:
diethylhydroxylamine;
triphenylphosphite; and
basic strontium.

29. The antiskinning composition of claim 28, wherein the basic strontium is strontium carboxylate.

30. The antiskinning composition of claim 29, comprising:
about 40 to about 95 weight percent diethylhydroxylamine;
about 5 to about 20 weight percent triphenylphosphite; and
up to about 40 weight percent strontium carboxylate.
